(19) United States
(12) Patent Application Publication
(10) Pub. No.: US 2014/0009385 A1
(43) Pub. Date: Jan. 9, 2014

(54) METHOD AND SYSTEM FOR ROTATING DISPLAY IMAGE

(71) Applicant: ASUSTeK COMPUTER INC., Taipei (TW)

(72) Inventors: Calvin Wing-Hang KU, Taipei (TW); Wei-Wen LUO, Taipei (TW); Wen-Chieh TSENG, Taipei (TW)

(21) Appl. No.: 13/922,553

(22) Filed: Jun. 20, 2013

Related U.S. Application Data
(60) Provisional application No. 61/668,184, filed on Jul. 5, 2012.

(30) Foreign Application Priority Data
May 3, 2013 (TW) 102115984

(51) Int. Cl. G09G 5/32; G06F 3/01

(52) U.S. Cl. CPC G09G 5/32; G06F 3/013
USPC 345/156

(57) ABSTRACT

A method and a system for rotating a display image applied to an electronic display device which includes a display image are provided. The method includes at least the following steps: enabling a rotation mode; capturing user information relative to the electronic display device via an image capturing unit; receiving the user information via an analysis unit and generating analysis information according to the user information; and receiving the analysis information via a processing unit and generating a control signal to control the display image to rotate according to the analysis information.

### CROSS REFERENCE TO RELATED APPLICATION

This application claims the priority benefit of U.S. provisional application Ser. No. 61/668,184, filed on Jul. 5, 2012, and Patent Application No. 102115984 filed in Taiwan, Republic of China on May 3, 2013. The entirety of the above-mentioned patent application is hereby incorporated by reference herein and made a part of specification.

### BACKGROUND OF THE INVENTION

1. Field of the Invention

The invention relates to a method and a system of a display image, and more particularly, to a method and a system for rotating a display image.

2. Description of the Related Art

With the improvement of miniaturization and portability of electronic products, it gradually becomes mature to use a smart phone, a tablet computer or a notebook to browse webpages, read an electronic document, watch a film or application of a personal digital assistant (PDA).

Most display devices are configured with gyroscopes to facilitate users operating in different angles. When a user tilts an electronic device by an angle, a display image will be changed to the tilted angle to meet requirements. However, it is not an intuitive and accurate method to determine the operation state of a user according to a rotating angle of the device.

### BRIEF SUMMARY OF THE INVENTION

A method and a system for rotating a display image which provide the users better and more intuitive experience to meet requirements are provided.

In an embodiment of the invention, a method and a system for rotating a display image automatically according to a using state relative to an electronic display device are provided, which need not rotate the electronic display device.

In an embodiment of the invention, a method for rotating a display image applied to an electronic display device which includes a display image is provided. The method includes at least the following steps: enabling a rotation mode; capturing user information relative to the electronic display device via an image capturing unit; receiving the user information via an analysis unit and generating analysis information according to the user information; receiving the analysis information via a processing unit and generating a control signal to control the display image to rotate according to the analysis information.

In an embodiment of the invention, a system for rotating a display image applied to an electronic display device which includes a display image is provided. The system includes an image capturing unit, an analysis unit and a processing unit, wherein the analysis unit is electrically connected to the image capturing unit and the processing unit is electrically connected to the analysis unit.

The image capturing unit captures the user information relative to the electronic display device. The analysis unit receives the user information and generates analysis information according to the user information. Then, the processing unit receives the analysis information and generates a control signal to control the display image of the electronic display device to rotate according to the analysis information.

### BRIEF DESCRIPTION OF THE DRAWINGS

FIG. 1 is a block diagram showing a system for rotating a display image first embodiment;

FIG. 2 is a block diagram showing a system for rotating a display image in a second embodiment;

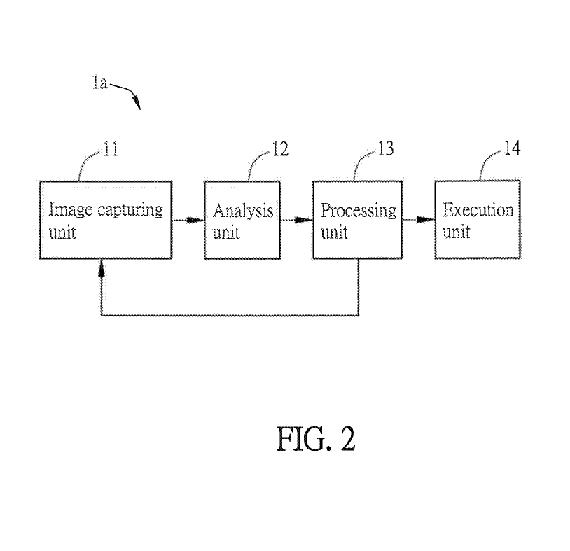

FIG. 3 is a flow chart showing a method for rotating a display image in a first embodiment;

FIG. 4 is an schematic diagram showing an application of a method for rotating a display image in an embodiment; and

FIG. 5 is an schematic diagram showing another application of a method for rotating a display image in an embodiment.

### DETAILED DESCRIPTION OF THE EMBODIMENTS

Structures of the system, method steps and application indicated situation for rotating a display image are illustrated with relating figures, and the same symbols denote the same structures, steps and components. In order to facilitate understanding, the structures, the steps and the components not directly related to the invention are omitted. Additionally, the electronic display device described below may be a notebook, a tablet computer (PC), a desktop or a smartphone, which is not limited herein.

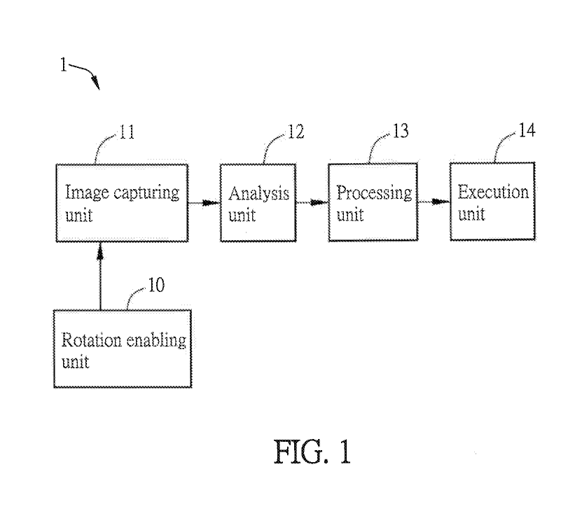

FIG. 1 is a block diagram showing a system for rotating a display image in a first embodiment. A system 1 includes an image capturing unit 11, an analysis unit 12 and a processing unit 13. The system 1 may further include an execution unit 14. The analysis unit 12 is electrically connected to the image capturing unit 11. The processing unit 13 is electrically connected to the analysis unit 12. The execution unit 14 is electrically connected to the processing unit 13.

The image capturing unit 11 captures user information relative to the electronic display device, in other words, the image capturing unit 11 captures a user image and converts the user image into a coordinate to make the system get a relative position relation between the user and the electronic display device (for example, whether a user's browsing direction is the same to that of the display image).

The image capturing unit 11, such as an eye tracking component, can capture an eye image, an eye coordinate or their combination and transmit them to the analysis unit 12. The eye image is an outline of user eyes, the eye coordinate is a defined iris outline by positioning a junction between an iris and a conjunctiva. No matter which of an eye image, an eye coordinate or their combination is captured, it will be converted into an absolute coordinate and transmitted to the analysis unit 12. The image capturing unit 11 can also be a camera component, such as a camera, to capture one or a combination of an eye image, an eye coordinate, a face image, a head outline, an upper part outline of a body, and the captured information is transmitted to the analysis unit 12 to further analyze a relative relation between the user and the display image.

Then, the analysis unit 12 receives the captured user information and generates analysis information according to the user information. The analysis information may be a user eye coordinate (an eye tracking component) or a tilt angle of a user head image according to different image capturing units 11. In detail, if the image capturing unit 11 is the eye tracking component, the captured image can be mapped to the display image, and an eye coordinate is generated, the analysis unit 12 can determine whether a user sight direction in browsing (or a moving path in browsing) is the same as the direction of the display image or an image arrangement. If the camera component is used, the analysis unit 12 further analyzes the image, for example, the camera component can capture a head image, and then the analysis unit 12 determines whether the user head has a tilt angle and whether a browsing direction and the display image are in same direction by analyzing a relative relation between the user nose and lip.

The processing unit 13 receives the analysis information and generates a control signal. The display image of the electronic display device determines whether the display image rotates according to the control signal. The execution unit 14 receives the control signal and makes the display device rotate by an angle. For example, the analysis information shows that a head of a user tilts more than 45 degrees towards the right, the processing unit 13 indicates the execution unit 14 to rotate the display image by 90 degrees in clockwise. Otherwise, if the analysis information shows that a head of a user tilts less than 45 degrees, the processing unit 13 indicates the execution unit 14 not to rotate the display image (or no control signal is transmitted, and the execution unit 14 shows a standby state).

The processing unit 13 and the execution unit 14 in this embodiment are independent units and structures, however, they are also may be integrated at a signal chip to achieve the same effect in this embodiment, which is not limited herein.

The system 1 further includes a rotation enabling unit 10, which is electrically connected to the image capturing unit 11 to selectively enable the image capturing unit 11. In other words, if the rotation enabling unit 10 is selected to enable the image capturing unit 11, an enable signal is transmitted to the image capturing unit 11 to enable the image capturing unit 11. In practice, an operation-interface (such as a User Interface) or a physical button of a setting menu may be set at a software interface or a surface of the electronic display device to make the user select whether to enable the rotation enabling unit. If the user selects not to enable the rotation mode, a gyroscope, a magnetic sensor or a gravity sensor may be used as a way to determine the rotation of the display image.

“Rotating a display image” in the invention is not limited that rotating an original display image, if the original display image has several separate pictures (such as software shortcuts or shortcut keys), the arrangement of the pictures can be adjusted to the arrangement which most conforms to the image while rotating.

Additionally, “a user's browsing direction is the same to that of the display image” represents that if the browsing direction is from up to down, the display image and the arrangement direction are also from up to down, the browsing direction should not be confused with a reading direction.

FIG, 2 is a block diagram showing a system for rotating a display image in a second embodiment. A system la in this embodiment does not include the rotation enabling unit 10 which is different from the system 1 in the first embodiment. The processing unit 13 is electrically connected to the image capturing unit 11, and the processing unit 13 transmits the enable signal to enable the rotation mode. In other words, the processing unit 13 controls the execution unit 14 and enables the image capturing unit 11 directly.

The rest structures and the connection relationships between the units in this embodiment are same to these in the first embodiment, which is omitted herein.

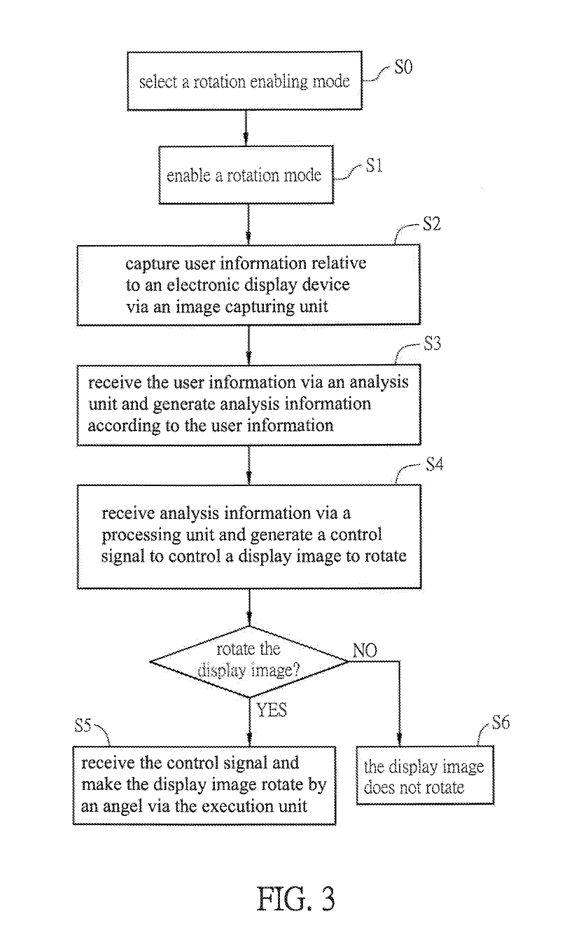

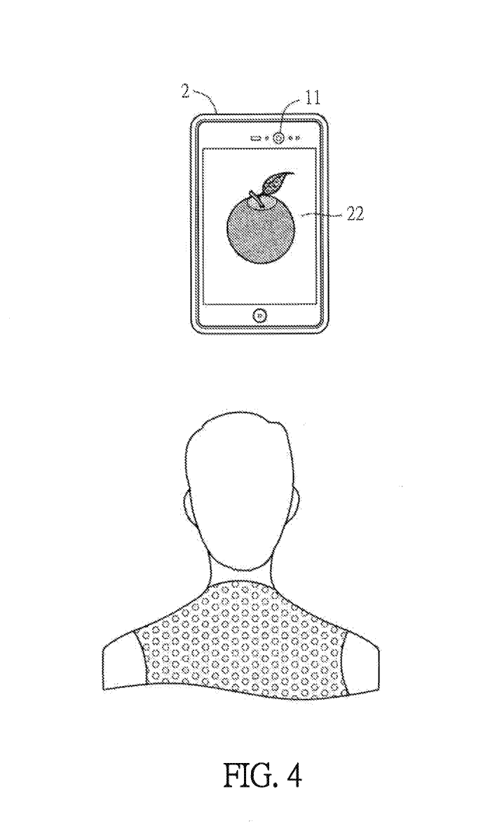

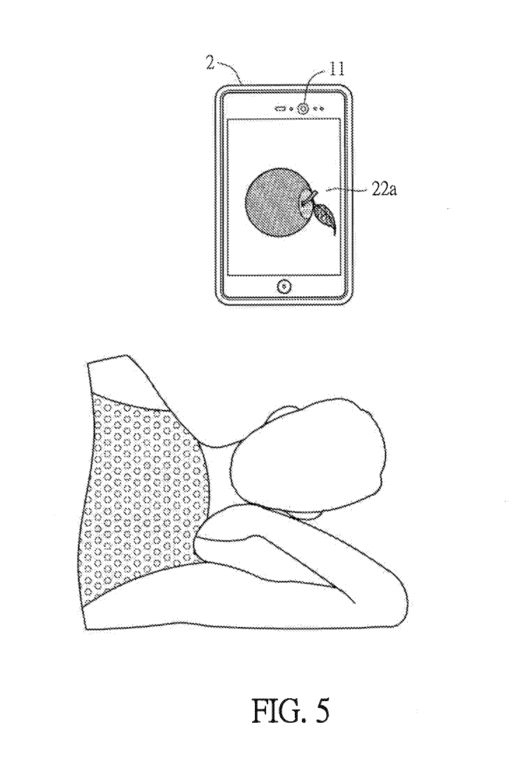

Please refer FIG. 3 to FIG. 5, FIG. 3 is a flow chart showing a method for rotating a display image, FIG. 4 and FIG. 5 are schematic diagrams showing application of a method for rotating a display image applied to an electronic display device 2 which includes a display image 22. The electronic display device 2 may be a smart phone, a desktop computer, a tablet computer or a notebook, a tablet computer is taken as an example herein. The image capturing unit 11 is disposed at the side of the display image 22, the type and the configuration of the electronic display device 2 are not limited herein.

Please refer to the flow chart in FIG. 3, the method for rotating a display image at least includes the following steps:

First, a rotation mode is enabled in step S1. The display image 22 may have an operation interface (not shown), the operation interface may be but not limited to a User interface (UI), the user can enable the rotation mode via the operation interface. The rotation mode can also be enabled via a physical button.

Then, the image capturing unit 11 captures the user information relative to the electronic display device 2 in step S2. Different image capturing units 11 can capture different user information. If the image capturing unit 11 is an eye tracking component, the user information may be an eye image, an eye coordinate or their combination. If the image capturing unit 11 is a camera component, the user information may include one or a combination of an eye image, an eye coordinate, a face image, a head image, an upper part outline of a body.

Then, the analysis unit receives the user information and generates the analysis information according to the user information in step S3, wherein the analysis information may be a user eye coordinate.

The processing unit 13 receives the analysis information and generates a control signal according to the analysis information in step S4.

Additionally, the method may further include step S5. In step S5, the processing unit 13 determines whether a tilt direction of the sight or the head of the user reaches a level to rotate the display image. If yes, the execution unit 14 receives the control signal and makes the display image rotate by an angle.

For example, when the tilt degree is more than 45 degrees in clockwise in FIG. 5, the processing unit 13 provides a control signal and indicates the execution unit 14 to rotate the display image by 90 degrees in clockwise (the display image 22a in FIG. 5 is rotated by 90 degrees) to cooperate with the user browsing direction. Then, the user need not rotate or tilt the electronic display device and can continue to see photos, films or surf the internet.

When the tilt angle is less than 45 degrees in FIG. 4, it determines that it does not need to rotate the display image 22. Then, the processing unit 13 transmits a control signal to the execution unit 14 (or no control signal is transmitted to make the execution unit 14 standby) to make the display image 22 not rotate.

The rest structures and the connection relationships between the units in this embodiment are same to these in the first embodiment, which is omitted herein.

The method may further inc hide step S0, the rotation mode is selectively enabled. The user can select whether to enable the rotation mode via an operation interface, such as a User Interface or a physical button.

In conclusion, according to a method and a system for rotating a display image in embodiments, an image capturing unit is used to capture a user image, analyze the information of the user eyes, a face or an outline, and then the display image can be directly and intuitively rotated. Consequently, the system and the method can provide the user better and more intuitive using experience, and the determining way is more accurate compared with the conventional determining way which is just according to the rotation of the device and an absolute tilt angle.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A method for rotating a display image, applied to an electronic display device which includes a display image, the method comprising:
enabling a rotation mode;
capturing user information relative to the electronic display device via an image capturing unit;
receiving the user information via an analysis unit and generating analysis information according to the user information; and
receiving the analysis information via a processing unit and generating a control signal to control the display image to rotate according to the analysis information.

2. The method for rotating the display image according to claim 1, further including:
receiving the control signal and making the display image rotate by an angle via an execution unit.

3. The method for rotating the display image according to claim 1, wherein the image capturing unit is an eye tracking component.

4. The method for rotating the display image according to claim 1, wherein the user information includes one or a combination of an eye image, an eye coordinate, a face image, a head image, an upper part of a body.

5. The method for rotating the display image according to claim 1, wherein the step of generating the analysis information according to the user information includes:
analyzing a relative position between a nose and a lip in a head image;
determining a tilt angle of the head image according to the relative position; and generating the analysis information.

6. A system for rotating a display image, applied to an electronic display device which includes a display image, comprising:
an image capturing unit capturing user information relative to the electronic display device;
an analysis unit electrically connected to the image capturing unit, receiving the user information, and generating analysis information according to the user information; and
a processing unit electrically connected to the analysis unit, wherein the processing unit receives the analysis information, generates a control signal according to the analysis information, and the control signal controls the display image of the electronic display device to rotate.

7. The system for rotating the display image according to claim 6, further including an execution unit receiving the control signal and making the display image rotate an angle.

8. The system for rotating the display image according to claim 6, wherein the electronic display device is a smart phone, a desktop computer, a tablet computer or a notebook.

9. The system for rotating the display image according to claim 6, wherein the image capturing unit is an eye tracking component.

10. The system for rotating the display image according to claim 6, wherein the user information includes one or a combination of an eye image, an eye coordinate, a face image, a head outline, an upper part outline of a body.

11. The system for rotating the display image according to claim 6, further including a rotation enabling unit electrically connected to the image capturing unit,

12. The system for the rotating display image according to claim 6, wherein the processing unit is electrically connected to the image capturing unit.
